(19) United States
(12) Patent Application Publication
(10) Pub. No.: US 2003/0143372 A1
(43) Pub. Date: Jul. 31, 2003

(54) Antibacterial toilet tissue

(76) Inventor: Beverly Richard, Houston, TX (US)

Correspondence Address: KENNETH D. BAUGH, 2413 Blodgett, Houston, TX, 77004, US

(21) Appl. No.: 10/057,346

(22) Filed: Jan. 28, 2002

(51) Int. Cl. B32B 3/10

(52) U.S. Cl. 428/138

(57) ABSTRACT

An antibacterial tissue 10 is provided. The tissue 10 includes an upper planar shaped absorbent member 12, and an intermediate planar shaped absorbent member 18. A dry antibacterial member 22, which is activated by moisture, is formed on the intermediate planar shaped absorbent member 18 and coupled between the upper planar shaped absorbent member 12 and the intermediate planar shaped absorbent member. A lower planar shaped absorbent member 24 is coupled to a lower surface of the intermediate planar shaped absorbent member 18. As a result an antibacterial tissue 10 is formed to facilitate bacterial removal while the tissue is being used.

### TECHNICAL FIELD

This invention relates to toilet tissue and more particularly to an antibacterial toilet tissue for protecting a user from bacterial agents that may exist after the waste elimination process while using bathroom facilities. Cleanliness is an ongoing concern because of the health consequences associated therewith. Cleanliness is of particular concern when individuals are using bathroom facilities. Normally, this concern is addressed with tissue products such as toilet paper. This solution however does not necessarily deal with all the bacterial conditions that may result from this process. Thus it is desirable to have a tissue product that maximizes the opportunity to eliminate any bodily bacteria that may result from individuals use of bathroom facilities.

### BACKGROUND ART

There have been a number of attempts to deal with sanitary tissue products. However none of these products specifically address the enhancement of the sanitary characteristics of the product. All of these products emphasize the characteristic of the paper product itself. One such arrangement is disclosed in U.S. Pat. No. 5,972,456. This product addresses the sanitation issue indirectly emphasizing the thickness of the paper. Another arrangement is disclosed in U.S. Pat. No. 5,652,035. This product addresses the rigidity of the product and the structure thus also only address the sanitation issue indirectly.

Still another paper product is disclosed in U.S. Pat. No. 4,582,743. This product is also concerned with the paper itself and specifically achieving greater paper thickness in the papers central area.

### DISCLOSURE OF THE INVENTION

A toilet tissue is provided for enhancing the sanitary conditions of a user. The toilet tissue of this invention includes an upper planar shaped absorbent member. The toilet tissue also includes an intermediate planar shaped absorbent member having a plurality of spaced aligned openings formed therein. The intermediate member has formed thereon a dry antibacterial member which is activated by moisture. The intermediate member is aligned with and coupled to the upper planar member so that the antibacterial member is sandwiched therebetween. A lower planar member is aligned with and coupled to the intermediate member on a surface opposite the antibacterial agent thereby forming the tissue of this invention.

### BRIEF DESCRIPTION OF THE DRAWING

The details of the invention will be described in connection with the accompanying drawing in which:

FIG. 1 is a perspective view illustrating an antibacterial toilet tissue in accordance with the principles of the invention.

FIG. 2 is a cross-sectional view taken along line 2-2 of FIG. 1.

FIG. 3 is a plain view illustrating an intermediate member of the antibacterial toilet tissue having an antibacterial layer formed thereon in accordance with the principles of the invention.

FIG. 4 is a perspective view illustrating a second embodiment of an antibacterial toilet tissue in accordance with the principles of the invention.

FIG. 5 is a cross-sectional view taken along line 5-5 of FIG. 4.

FIG. 6 is a plain view illustrating an intermediate member of the antibacterial toilet tissue having an antibacterial layer formed thereon in accordance with the principles of the invention.

### BEST MODE FOR CARRYING OUT THE INVENTION

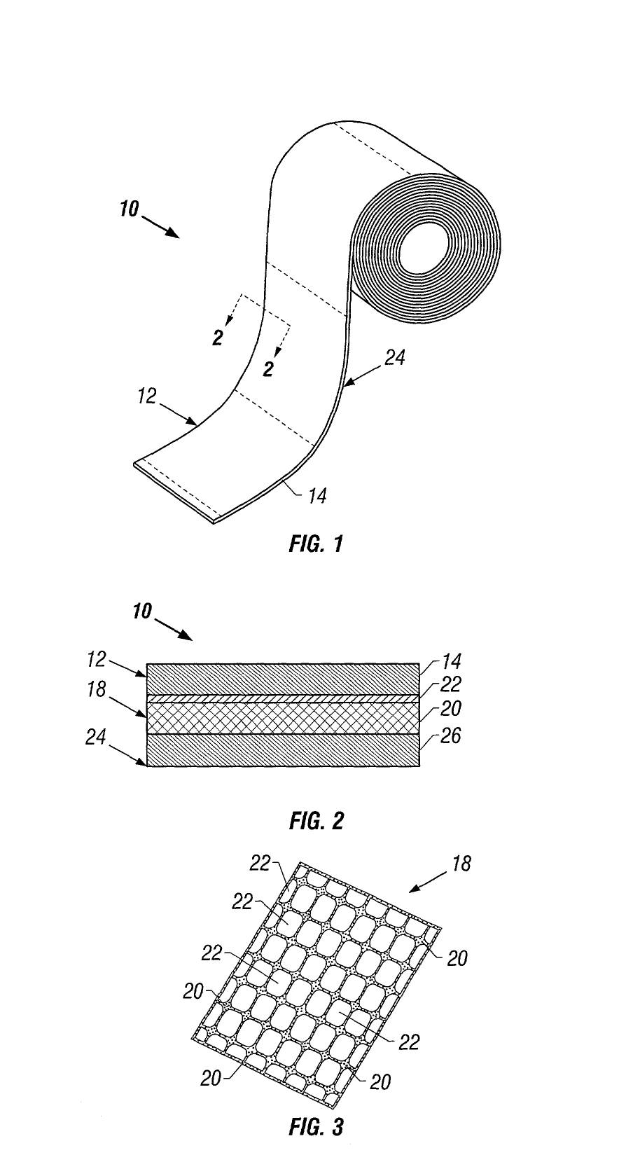

Referring to FIGS. 1 and 2 there is shown, an antibacterial toilet tissue, generally designated, by the numeral, 10. The tissue 10 includes an upper planar shaped absorbent member, generally designated, by the numeral 12 (FIG. 2). The upper planar shaped absorbent member 12 includes a first absorbent member 14. The first absorbent member 14, can be made, for example, of a thin one ply paper like absorbent material which will let liquid substances flow therethrough.

The toilet tissue 10 also includes an intermediate planar shaped absorbent member, generally designated, by the numeral, 18 having a plurality of spaced aligned openings 20 formed therein (FIG. 2). The intermediate planar shaped absorbent member 18, may be, for example a paper mesh like material. The intermediate planar shaped absorbent member 18 has formed on an upper surface thereof a dry antibacterial member 22 (FIG. 3). The antibacterial member 22 is activated by moisture from the body or other source of available moisture. The antibacterial member 22, may be made, for example, of an antibacterial agent such as for example, betadine or an antibacterial soap. The intermediate planar shaped absorbent member 18 is aligned with the upper planar shaped absorbent member 12 so that the antibacterial member 22 is sandwiched between the upper planar absorbent member and the intermediate planar shaped absorbent member.

The tissue 10 is also provided with a lower planar shaped absorbent member, generally designated, by the numeral, 24. The lower planar shaped absorbent member 24 is provided with a second absorbent member 26. The second absorbent member 26 is adjacently aligned with and coupled to a lower surface of the intermediate planar shaped absorbent member 18. The second absorbent member 26, can each be made, for example, of a thin one ply paper like absorbent member as is the first absorbent member 14. The members 12, 18, 22 and 24 are coupled together in a well known manner.

When it is desired to use the tissue 10 a user can simply roll the desired amount of tissue from the roll and use it in a well known manner. When being used moisture from the user's body or an external source of moisture will activate the antibacterial member 22. As a result the antibacterial member can then be dispensed through the absorbent layers so that bacterial agents are eliminated.

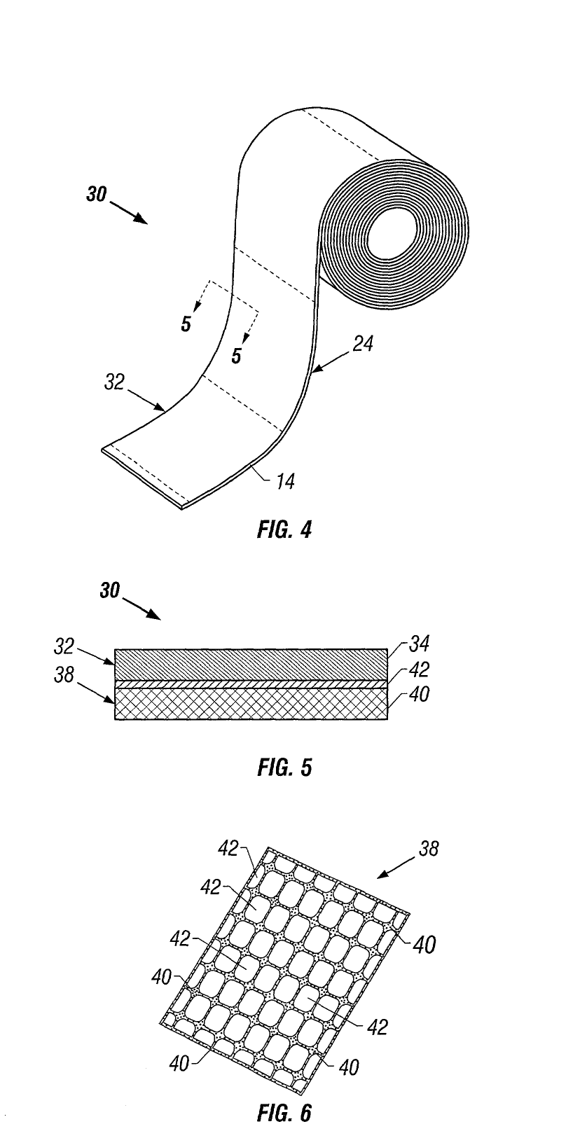

Referring to FIGS. 4 and 5 there is shown, a second embodiment of an antibacterial toilet tissue, generally designated, by the numeral, 30. The tissue 30 includes an upper planar shaped absorbent member, generally designated, by the numeral 32 (FIG. 4). The upper planar shaped absorbent member 32 includes a first absorbent member 34. The first absorbent member 34, can each be made, for example, of a thin one ply paper like absorbent material which will let liquid substances flow therethrough.

The toilet tissue 30 also includes a lower planar shaped absorbent member, generally designated, by the numeral, 38 having a plurality of spaced aligned openings 40 formed therein (FIG. 6). The lower planar shaped absorbent member 38, may be, for example a paper mesh like material. The lower planar shaped absorbent member 38 has formed on an upper surface thereof a dry antibacterial member 42 (FIG. 6). The antibacterial member 42 is activated by moisture from the body or other source of available moisture. The antibacterial member 42, may be made, for example, of an antibacterial agent such as, for example, betadine or an antibacterial soap. The lower planar shaped absorbent member 38 is aligned with the upper planar shaped member 32 so that the antibacterial member 42 is sandwiched between the upper planar shaped absorbent member and the lower planar shaped absorbent member. The members 32, 38 and 42 are coupled together in a well known manner.

When it is desired to use this embodiment of the invention a user can simply roll the desired amount of tissue 30 from the roll and use it in a well known manner. When being used moisture from the user's body or an external source of moisture will activate the antibacterial member 42. As a result the antibacterial member 42 can then be dispensed through the absorbent layers so that bacterial agents are eliminated.

The invention has been shown and described in what is considered to be the most practical and preferred embodiment. However, it should be recognized that changes may be made by those skilled in the art without departing from the spirit of the invention

What is claimed:

1. An antibacterial tissue including:
an upper planar shaped absorbent member;
an intermediate planar shaped absorbent member having a plurality of apertures formed therein coupled to the upper planar shaped absorbent member;
an antibacterial member formed on an upper surface of the intermediate planar shaped absorbent member between the upper planar shaped absorbent member and the intermediate planar shaped absorbent member; and
a lower planar shaped absorbent member coupled to a lower surface of the intermediate planar shaped absorbent member.

2. An antibacterial tissue as defined in claim 1 wherein the upper planar shaped absorbent member includes a thin paper-like absorbent material.

3. An antibacterial tissue as defined in claim 2 wherein the intermediate planar shaped absorbent member includes a thin paper-like material having a plurality of openings formed therein.

4. An antibacterial tissue as defined in claim 3 wherein the antibacterial member is a dry antibacterial member which is activated by moisture.

5. An antibacterial tissue as defined in claim 4 wherein the antibacterial member includes a layer of antibacterial soap.

6. An antibacterial tissue as defined in claim 4 wherein the antibacterial member includes a layer of betadine.

7. An antibacterial tissue including:
an upper planar shaped absorbent member;
a lower planar shaped absorbent member having a plurality of apertures formed therein coupled to the upper planar shaped absorbent member; and
an antibacterial member formed on an upper surface of the lower planar shaped absorbent member between the upper planar shaped absorbent member and the lower planar shaped absorbent member.

8. An antibacterial tissue as defined in claim 7 wherein the upper planar shaped absorbent member includes a thin paper-like absorbent material.

9. An antibacterial tissue as defined in claim 8 wherein the lower planar shaped absorbent member includes a thin paper-like material having a plurality of openings formed therein.

10. An antibacterial tissue as defined in claim 9 wherein the antibacterial member is a dry antibacterial member which is activated by moisture.

11. An antibacterial tissue as defined in claim 10 wherein the antibacterial member includes a layer of antibacterial soap.

12. An antibacterial tissue as defined in claim 10 wherein the antibacterial member includes a layer of betadine.
